(19) United States
(12) Patent Application Publication
(10) Pub. No.: US 2008/0298983 A1
(43) Pub. Date: Dec. 4, 2008

(54) FAN, MOTOR AND BEARING STRUCTURE THEREOF

(76) Inventors: Shang-Mau TSAI, Taoyuan Hsien (TW); Kuo-Tung Hsu, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/039,512

(22) Filed: Feb. 28, 2008

(30) Foreign Application Priority Data
May 31, 2007 (TW) 096119493

(51) Int. Cl. F04D 29/046; F16C 33/04; H02K 5/16; F04B 35/04; F04D 19/00; F04D 29/00

(52) U.S. Cl. 417/354; 384/276; 310/90

(57) ABSTRACT

A fan includes an impeller and a motor. The motor includes a rotor structure and a bearing structure. The motor is used to drive the impeller and the rotor structure has a shaft. The shaft is connected to the impeller. The bearing structure includes an oil-retaining bearing, a base and a sleeve. The oil-retaining bearing is used to dispose the shaft and the base is used to support the oil-retaining bearing. The sleeve includes at least one resisting part and a circular sidewall. The circular sidewall is covered the outside of the oil-retaining bearing. The resisting part is disposed on the top surface of the circular sidewall and extended to the center of the oil-retaining bearing.

### CROSS REFERENCE TO RELATED APPLICATIONS

This Non-provisional application claims priority under 35 U.S.C. §119(a) on Patent Application No(s). 096119493, filed in Taiwan, Republic of China on May 31, 2007, the entire contents of which are hereby incorporated by reference.

### BACKGROUND OF THE INVENTION

1. Field of the Invention

The present invention relates to a fan, a motor and a bearing structure thereof, and more particularly to a fan, a motor and a bearing structure thereof capable of preventing deformation and increasing lifetime of the fan, the motor and the bearing structure thereof.

2. Description of the Related Art

Many apparatuses, such as fans, are driven to work by a motor. Good or bad operation of the motor affects the performance of the apparatuses. A bearing is an important element for the motor of a fan. If the bearing does not cushion and fix an axle, noise will be generated or lifetime of the motor will decrease.

FIG. 1 is a schematic illustration of a conventional axial fan. The bearing structure usually includes a metal sleeve and an oil-retaining bearing 131 for lubricating. Sometimes, an oil seal o is added into the bearing structure for preventing evaporation of the lubricating oil. Thus, the shaft 12 of the axial fan does not directly contact to the oil-retaining bearing 131 to prevent wearing.

To decrease costs, the metal sleeve is replaced with a plastic sleeve 132. Because the hardness of the plastic sleeve 132 is different from that of the oil-retaining bearing 131, friction between the plastic sleeve 132 and the oil-retaining bearing 131 is hard to be controlled. When the plastic sleeve 132 and the oil-retaining bearing 131 are firmly combined, friction is generated. The oil-retaining bearing 131 generates a shrinkage hole. Thus, the interval between the plastic sleeve 132 and the oil-retaining bearing 131 decreases. Relatively, the space to store lubricating oil decreases, reducing lubricant efficiency. Thus, noise is generated and the shaft 12 of the fan is worn away. The lifetime of the fan decreases.

If the friction between the plastic sleeve 132 and the oil-retaining bearing 131 is small, the oil-retaining bearing 131 may be easily loosened to form a gap because of vibration. In this example, the lubricating oil will flow everywhere along the gap. Furthermore, small friction causes the oil seal 133 not to be fixed on the oil-retaining bearing 131. Thus, it is possible that the oil seal 133 detaches or moves, resulting in inconvenience.

### BRIEF SUMMARY OF INVENTION

A detailed description is given in the following embodiments with reference to the accompanying drawings. The present invention provides a fan, a motor and a bearing structure thereof, which improves the influence about the friction between the oil-retaining bearing and plastic sleeve, decreases noise, prevents deformation and looseness of the oil-retaining bearing and thus increases the lifetime of the fan. Furthermore, a fan, motor and bearing structure thereof use cheap plastic sleeve to decrease the cost for increasing product competitiveness.

The present invention provides a bearing structure including an oil-retaining bearing, a base, and a sleeve. The oil-retaining bearing is telescoped with the shaft. The base supports the oil-retaining bearing. The sleeve includes at least one resisting part and a circular sidewall. The circular sidewall covers an outside of the oil-retaining bearing. The resisting part is disposed on a top surface of the circular sidewall and extends to the center of the oil-retaining bearing.

The present invention provides a fan, for example an axial fan, including an impeller and a motor. The motor includes a rotor structure and a bearing structure. The motor drives the impeller to rotate. The rotor structure includes a shaft connected to the impeller. The bearing structure includes an oil-retaining bearing, a base, and a sleeve. The oil-retaining bearing is disposed on the shaft. The base supports the oil-retaining bearing. The sleeve includes at least one resisting part and a circular sidewall. The circular sidewall covers an outside of the oil-retaining bearing. The resisting part is disposed on a top surface of the circular sidewall and extends to the center of the oil-retaining bearing.

The resisting part of the fan, motor and bearing structure thereof is connected to a top surface of the oil-retaining bearing. The resisting part adjoins the shaft. The resisting part completely covers the top surface of the circular sidewall or covers at least a part of the top surface of the circular sidewall. The sleeve is made of macromolecular polymer. The hook-shaped resisting part is manufactured by hot melt. The circular sidewall, the resisting part and the oil-retaining bearing form a space. The fan further includes an oil seal disposed between the resisting part and the oil-retaining bearing. The space accommodates a part of the oil seal. The base and the sleeve are formed as a single unit.

### BRIEF DESCRIPTION OF DRAWINGS

The present invention can be more fully understood by reading the subsequent detailed description and examples with references made to the accompanying drawings, wherein:

FIG. 1 is a cross-sectional view of a conventional axial fan;

FIG. 2A is cross-sectional view of a fan of a preferred embodiment of the present invention;

FIG. 2B is a partial enlarged view of a sleeve in FIG. 2A;

FIG. 3A is a partial enlarged view of a bearing structure of the FIG. 2A;

FIG. 3B is a cross-sectional view of a bearing structure according to another embodiment of the present invention;

FIG. 4A is a vertical view of a bearing structure of the present invention; and

FIGS. 4B and 4C are vertical views of another two bearing structures according to embodiments of the present invention.

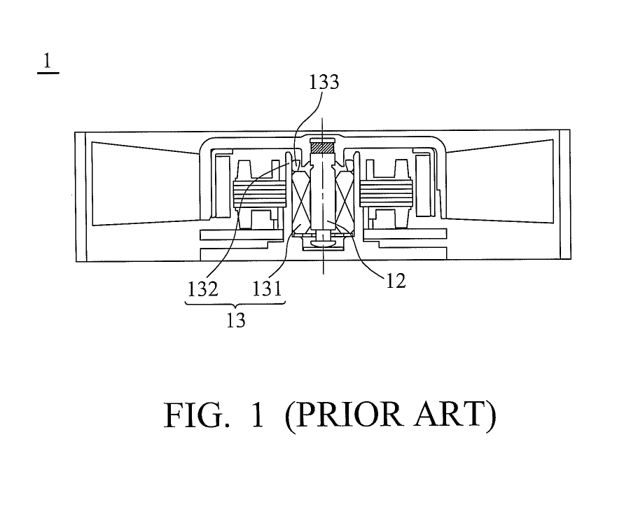

### DETAILED DESCRIPTION OF INVENTION

The following description is of the best-contemplated mode of carrying out the present invention. This description is made for the purpose of illustrating the general principles of the present invention and should not be taken in a limiting sense. The scope of the present invention is best determined by reference to the appended claims.

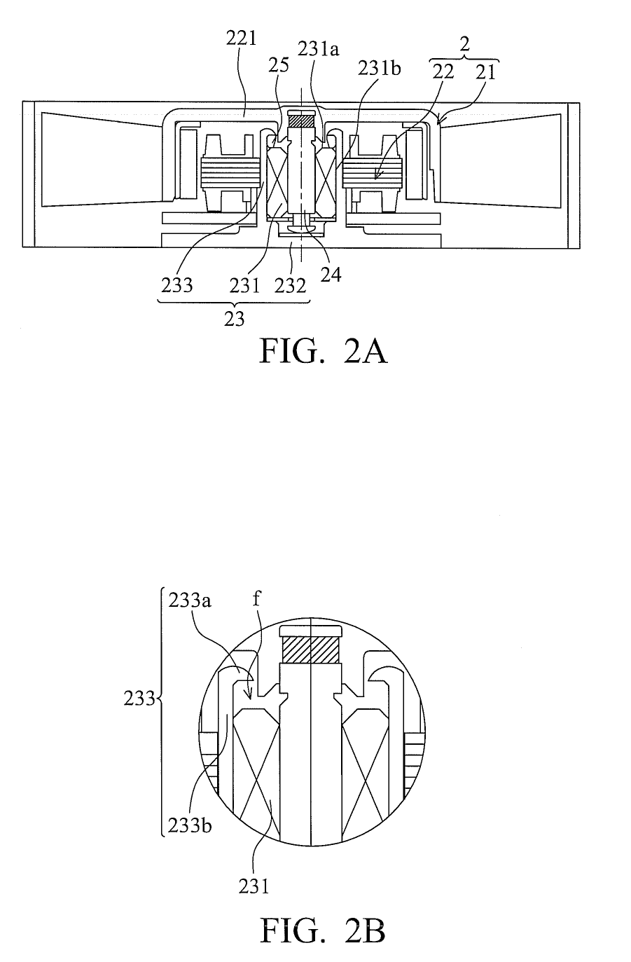

FIG. 2A is cross-sectional view of a fan of the present invention. FIG. 2B is a partial enlarged view of a sleeve in FIG. 2A. Referring to FIGS. 2A and 2B, the fan 2 includes an impeller 21 and a motor 22. The motor 22 includes a rotor structure 221 and a bearing structure 23. The motor 22 drives the impeller 21 to rotate. The rotor structure 221 includes a shaft s connected to the impeller 21. The bearing structure 23 includes an oil-retaining bearing 231, a base 232, and a sleeve 233. The base 232 supports the oil-retaining bearing 231. The base 232 and the sleeve 233 are integrally formed as a single piece. The oil-retaining bearing 231 is disposed on the shaft 24. The sleeve 233 includes at least one resisting part 233a and a circular sidewall 233b. The circular sidewall 233b of the sleeve 233 covers an outside 231b of the oil-retaining bearing 231. The resisting part 233a is disposed on a top surface of the circular sidewall 233b and extends to the center of the oil-retaining bearing 231.

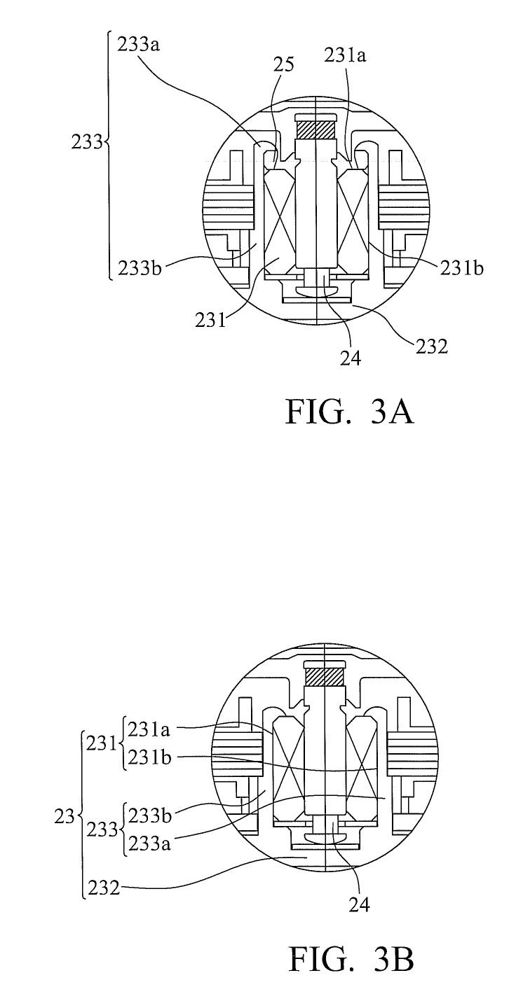

FIG. 3A is a partial enlarged view of a bearing structure of the FIG. 2A. FIG. 3B is a cross-sectional view of a bearing structure 23 according to another embodiment of the present invention. In the embodiment, the shrinkage hole of the oil-retaining bearing resulting in wear and tear of shaft s for conventional fans is prevented via the bearing structure 23. The internal diameter of the oil-retaining bearing 231 is slightly smaller than that of the sleeve 233. Thus, the oil-retaining bearing 231 can be disposed in the sleeve 233. The space between the oil-retaining bearing 231 and the sleeve 233 is very small. Deformation of the oil-retaining bearing 231 is prevented because there is no excessive friction between the oil-retaining bearing 231 and the sleeve 233. The sleeve is made of fusible macromolecular polymer capable of deformation for preventing the oil-retaining bearing 231 from loosing and the lubricating oil from leakage. When the oil-retaining bearing 231 is disposed on the circular sidewall 233b of the sleeve 233, a part of the circular sidewall 233b protruding from the oil-retaining bearing 231 is heated by a welding machine. Thus, heat is transmitted to the circular sidewall 233b to fuse the top surface of the circular sidewall 233b which is made of macromolecular polymer. The fused circular sidewall 233b is deformed to form the hook-shaped resisting part 233a toward the center of the oil-retaining bearing 231. The size of the resisting part 233a is adjustable via heated areas, time and pressure according to requirement.

The oil seal 25 is not connected to a top surface 231a of the oil-retaining bearing 231 by controlling the welding machine. A space f is formed between the circular sidewall 233b, the resisting part 233a and the oil-retaining bearing 231 shown in FIGS. 2A and 2B. The oil seal o in the space f is fixed, preventing the oil seal o from loosing, resulting in external matters falling and evaporation of the lubricating oil. If a bearing structure 23 without the oil seal o is used, the resisting part 233a is melted to connect to the top surface 231a of the oil-retaining bearing 231. Thus, the oil-retaining bearing 231 is fixed, too. If the resisting part 233a is disposed close to the shaft s, the fixing efficiency is improved. Note that the resisting part 233a extending to the center of the oil-retaining bearing 231 is not connected to the shaft s.

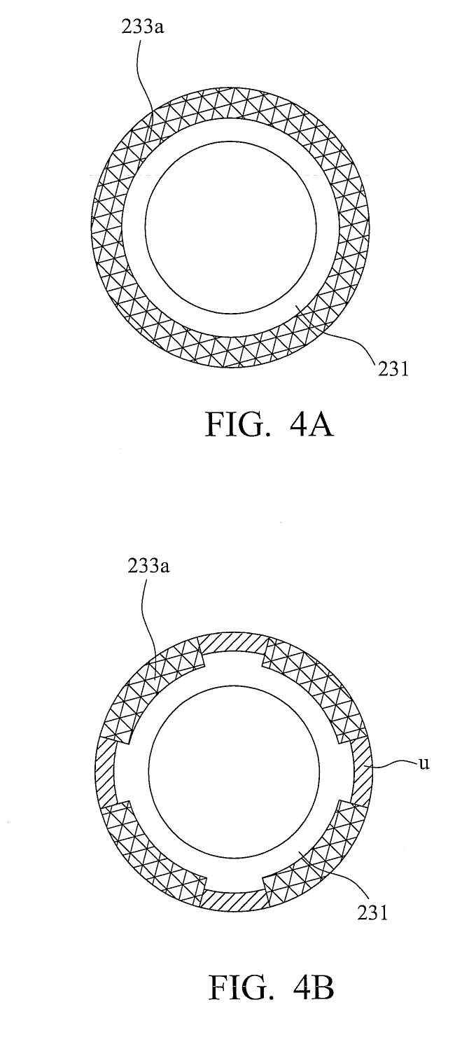

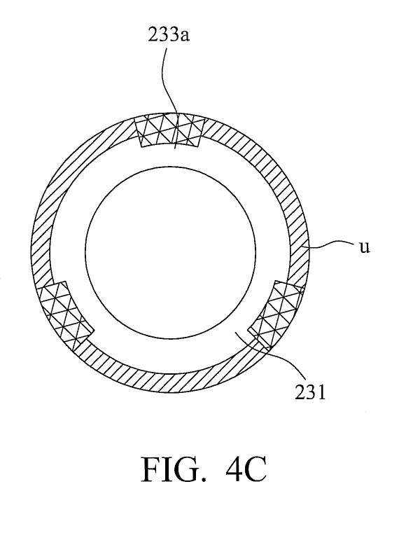

Variations of the resisting part 233a are shown in FIGS. 4A, 4B and 4C. FIG. 4A is a vertical view of a bearing structure of the present invention. FIGS. 4B and 4C are vertical views of another two bearing structures according to embodiments of the present invention. Referring to FIGS. 4A, 4B and 4C, the resisting part 233a is not limited to completely cover the upper surface u of the circular sidewall 233b. A plurality of resisting parts 233a with small areas is provided to fix to the top surface u of the circular sidewall 233b. The resisting parts 233a with small areas is formed by reserving a plurality of protrusions arranged symmetrically on the circular sidewall 233b, and melting the protrusions. The resisting parts 233a with small areas are formed as shown in FIGS. 4B and 4C. The resisting parts 233a arranged symmetrically are disposed on the top surface u of the circular sidewall 233b. The amount and the size of the resisting parts 233a with small areas are decided according to the requirements. When the bearing structure is applied to the motor 22 or the fan 2, the bearing structure is adjusted according to the properties of the product. Thus, the bearing structure is flexibly used.

The bearing structure provides the resisting parts 233a formed by melting the circular sidewall 233b, and fixing the oil-retaining bearing 231 or oil seal o, thereby preventing the oil-retaining bearing 231 from generating shrinkage hole or loosing due to the friction. If the problem of the friction is solved, the sleeve 233 made of macromolecular polymer is easily used for decreasing costs. Because the resisting part 233a extends to the center of the oil-retaining bearing 231, external matters falling and evaporation of the lubricating oil are prevented for increasing the lifetime of the bearing structure or the fan.

While the present invention has been described by way of example and in terms of the preferred embodiments, it is to be understood that the present invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A bearing structure, comprising:
an oil-retaining bearing, telescoped with a shaft;
a base, supporting the oil-retaining bearing; and
a sleeve comprising at least one resisting part and a circular sidewall;
wherein the circular sidewall covers an outside of the oil-retaining bearing, and the resisting part is disposed at a top surface of the circular sidewall and extends to a center of the oil-retaining bearing.

2. The bearing structure as claimed in claim 1, wherein the resisting part is connected to a top surface of the oil-retaining bearing, and is disposed adjacent to the shaft.

3. The bearing structure as claimed in claim 1, wherein the resisting part completely covers the top surface of the circular sidewall or covers at least a part of the top surface of the circular sidewall.

4. The bearing structure as claimed in claim 1, wherein the sleeve comprises macromolecular polymers.

5. The bearing structure as claimed in claim 4, wherein the resisting part is manufactured by hot melt, and the resisting part is hook-shaped.

6. The bearing structure as claimed in claim 1, wherein the circular sidewall, the resisting part and the oil-retaining bearing form a space, and the bearing structure further comprises an oil seal disposed between the resisting part and the oil-retaining bearing.

7. The bearing structure as claimed in claim 6, wherein the space accommodates a part of the oil seal.

8. The bearing structure as claimed in claim 1, wherein the base and the sleeve are integrally formed as a single piece.

9. A motor, comprising:
a rotor structure comprising a shaft; and
a bearing structure comprising:
an oil bearing, disposed on the shaft;
a base, supporting the oil bearing; and
a sleeve comprising at least one resisting part and a circular sidewall;
wherein the circular sidewall covers an outside of the oil bearing; and
the resisting part is disposed on an upper surface of the circular sidewall and extends to the center of the oil bearing.

10. The motor as claimed in claim 9, wherein the sleeve comprises macromolecular polymers, the resisting part is manufactured by hot melt to completely covers the top surface of the circular sidewall or covers at least a part of the top surface of the circular sidewall.

11. A fan, comprising:
an impeller; and
a motor comprising a rotor structure and a bearing structure, wherein the motor drives the impeller to rotate, the rotor structure comprises a shaft connected to the impeller;
wherein the bearing structure comprises an oil-retaining bearing, a base and a sleeve, the oil-retaining bearing is telescoped with the shaft, the base supports the oil-retaining bearing, the sleeve comprises at least one resisting part and a circular sidewall, the circular sidewall covers an outside of the oil-retaining bearing, and the resisting part is disposed at a top surface of the circular sidewall and extends to a center of the oil-retaining bearing.

12. The fan as claimed in claim 11, wherein the resisting part is connected to a top surface of the oil-retaining bearing and is disposed adjacent to the shaft.

13. The fan as claimed in claim 11, wherein the resisting part completely covers the top surface of the circular sidewall, or the resisting part covers at least a part of the top surface of the circular sidewall.

14. The fan as claimed in claim 11, wherein the sleeve comprises macromolecular polymers.

15. The fan as claimed in claim 14, wherein the resisting part is manufactured by hot melt, and the resisting part is hook-shaped.

16. The fan as claimed in claim 11, wherein the circular sidewall, the resisting part and the oil-retaining bearing form a space.

17. The fan as claimed in claim 16, further comprising an oil seal disposed between the resisting part and the oil-retaining bearing.

18. The fan as claimed in claim 17, wherein the space accommodates a part of the oil seal.

19. The fan as claimed in claim 11, wherein the base and the sleeve are integrally formed as a single piece.

20. The fan as claimed in claim 11, wherein the fan is an axial fan.
